(19) United States
(12) Patent Application Publication
(10) Pub. No.: US 2007/0036442 A1
(43) Pub. Date: Feb. 15, 2007

(54) Adaptive subtraction image compression

(76) Inventors: Jay H. Stoffer, Culver City, CA (US); Vijay Ramanathan, Toronto (CA); Sivaram Ramanathan, Toronto (CA)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 10/553,021

(22) PCT Filed: Apr. 9, 2004
(86) PCT No.: PCT/US04/10987

§ 371 Date: Sep. 8, 2006

Related U.S. Application Data
(60) Provisional application No. 60/461,821, filed on Apr. 11, 2003.

(51) Int. Cl. G06K 9/36

(52) U.S. Cl. 382/232

(57) ABSTRACT

The present invention provides methods and systems for compressing digital images by arranging the images in a series, subtracting the pixel of each of the images from its corresponding pixel in its adjacent image, adjusting the pixel value to zero for pixels having an absolute value less than a predetermined threshold value, and compressing said images using a compression algorithm to form compressed images. Images compressed in accordance with the invention can be reduced in size by at least about 60%. Compressed images can be stored, manipulated, and transferred with increased efficiency and speed at a greatly reduced cost.

### BACKGROUND OF THE INVENTION

Digital imaging technology is essential to diagnosis of a variety of diseases including cancer, heart disease, brain disorders, and many other conditions in both humans and animals. The ability to acquire, analyze, transfer, and store detailed images of tissues and organs permits rapid and accurate diagnosis of disease and therefore better and more accurate treatment for the patient. Digital images for use in medical diagnosis are often obtained as a series of images representing adjacent slices of a target such as an organ (e.g., liver, heart, brain) or other portion of the body. Radiologists and other medical professionals analyze the series of images to locate and identify potential pathological conditions. The use of a digital image series is not limited to the medical profession. For example, civil engineers may obtain images of roads, bridges, buildings, and other structures for analysis. Time lapse photography may be used to analyze the movements of stars, planets, meteors or other cosmic structures. Digital images of secure areas, locations, or objects may be used to determine if such areas, locations, or objects are moved or changed over time.

Billions of digital images for these and other applications are generated every year requiring considerable resources to analyze and transmit the images. For example, telemedicine relies on the ability to share medical images with professionals located in distant geographic locations. However, the available computer infrastructure for manipulating and transmitting large, numbers of digital images is often limited or unavailable. Transmission of large numbers of images is limited by the bandwidth of currently available networks (e.g., the Internet, phone lines, wireless transmission, satellite). Furthermore, the cost of transmitting large numbers of images is high and the availability of high bandwidth transmission is limited. Thus, images created with the most sophisticated technologies often need to be sent using slower and less efficient forms of delivery (e.g., courier or mail).

Rapid retrieval of these images is also limited by the size of the image files. Medical facilities, for example, must be able to rapidly retrieve images to meet the standards of the medical profession and comply with laws and regulations. Large image files are cumbersome and difficult to review and manipulate with many standard desktop systems. Companies may therefore be required to invest large amounts of capital in computer systems capable of efficiently and rapidly retrieving large image files.

Compression algorithms, such as JPEG, may be used to reduce the size of image files. Most lossy compression techniques have limited applicability where detection of minute differences between images in a series is critical. The loss of a small amount of detail may be tolerable for certain applications (e.g., entertainment media). In these non-critical applications, a user can balance the need for compression of the image size against the need for additional detail in the image. Critical application users (e.g., medical professionals) cannot tolerate the loss of detail that may be necessary to identify pathology in an image or series of images of a potentially diseased organ.

Medical images may be acquired using techniques such as computed tomography (“CT”) or magnetic resonance (“MR”). CT uses x-rays to image the body. As x-rays pass through the body, they are absorbed or attenuated at various levels creating a matrix or profile of x-ray beams of different strength. A rotating frame in the CT scanner has an x-ray tube mounted on one side and a detector mounted on the opposite side. A fan-shaped beam of x-ray radiation is created as the rotating frame spins the x-ray tube and detector around the patient. Each time the x-ray tube and detector make a 360° rotation, one or more images or slices has been acquired. The images represent slices of the body, and are usually completed in a series. The spacing between slices is typically less than five millimeters. The x-ray tube and detectors are normally moved along the long axis of the body to acquire axial images that illustrate the section of anatomy being studied. Typically, one or more coronal images are constructed as scout images to indicate the positioning of each axial image. An additional series of images may be acquired after a high-contrast material is injected into the patient. A derived image series may be computed from the original series to contain different windows for display, i.e., bone, lung, brain, etc. A derived series may also be created by different computer processing techniques such as enhancement filters and/or reconstruction.

MR uses magnetic energy and radio waves to create cross-sectional images or slices of the human body. Current MR scanners perform an examination typically comprised of 2 to 12 images in a series. An MR series is an acquisition of data that yields a specific image orientation and a specific type of image appearance. Among the benefits of MR are that it can differentiate tissue clearly and easily acquire direct views of the body in almost any orientation, while CT scanners can display bone fractures and typically acquire axial images.

There are a variety of compression methods of images described in the art. For example, the popular MPEG compression method is used to compress motion in video and eliminate significant differences between frames to exploit the limitation of the human eye, which cannot perceive differences that are visible in just a single frame when observing video recorded at 30 frames per second. MPEG compression is not applicable to diagnostic or medical imaging where the objective is to preserve significant differences between slices that may be indicative of pathology.

The paper, Karadimitriou and Tyler, Min-Max Compression for Medical Image Databases, ACM SIGMOD Record Volume 26, Issue 1, pgs. 47-52, 1997, describes the redundancy in sets of similar images (series) that occur in cross-sectional imaging. The encoding method discussed in Karadimitriou and Tyler refers to fitting a curve between the smallest and largest pixel value found at each pixel coordinate throughout the series. This method compresses images by a maximum factor of 3.4:1 as it does not remove random noise.

U.S. Pat. No. 6,269,193, “Young et al.,” refers to a compression method for use with a specific imaging device. The compression method refers to segmenting the foreground of an image followed by quantizing the pixel values of the foreground image below a calculated noise threshold. For example, if it is known that only 512 grayscales are significant out of the 65536 possible grayscales in a 16 bit image, then the 65536 grayscales can be mapped to 512 significant grayscales. However, this method can generally be implemented only by the manufacturer of the imaging device as each model and software version of imaging devices may have significantly different grayscale characteristics.

The paper, “Entropic Estimation of Noise for Medical Volume Restoration,” by Lieven et al. asserts that when adjacent CT or MR images are subtracted pixel-by-pixel from adjacent images within a series, the noise component doubles while most of the signal component is eliminated. Proceedings of the International Conference on Pattern Recognition ICPR'02, 2002. The histogram of this subtracted image is found to approximate a Gaussian distribution centered around 0 indicating the presence of a significant amount of “random noise.” The Lieven et al. article refers to the removal of noise in order to improve 3D volume rendering rather than for use in compression of images.

The paper entitled, “A rapid and efficient method data compression method for image time series,” by Cohen refers to the use of “thresholding” to remove random noise prior to compressing images that belong to a series. While the thresholding algorithm described by Cohen slightly improved the compression ratio, the output images were distorted and thus unsuitable for use in medical imaging, for example, because clinically significant information was not necessarily preserved.

U.S. Pat. No. 4,939,645 (“the '645 patent”) refers to a variety of computational methods for preserving the natural look of a diagnostic image that has been subject to lossy compression. However, the '645 patent is not directed to compression and refers to improving the appearance of images that have been subject to lossy compression.

What is needed are compression methods that substantially reduce the size of a series of digital images while preserving significant information contained in the original series of images.

### BRIEF SUMMARY OF THE INVENTION

A preferred embodiment of the invention is directed to a method of compressing a series of digital images by arranging the images in an ordered series from 1 to n wherein n is the last image in said series. Each pixel of each of images 2 to n are subtracted from its corresponding pixel in its adjacent image to create a subtracted image. Pixels having an absolute value less than a predetermined threshold value are adjusted to zero to create a thresholded image. The resulting thresholded image is compressed using a suitable compression algorithm (e.g., JPEG lossy, JPEG lossless, JPEG 2000 lossy, JPEG 2000 near lossless, JPEG 2000 lossless, JPEG-LS, RLE, Deflate, Lempel-Ziv) to form a compressed image. Another embodiment of the invention is directed to decompressing an image or reconstructing the compressed images using an associated decompression algorithm to form thresholded images and adding the pixels of each thresholded image 2 to n to the pixels of its adjacent reconstructed image. Alternatively, the adjacent images that were subtracted from during compression may be reconstructed adjacent images.

Methods of storing images compressed in accordance with the invention by encoding the images in a storage format including, but not limited to AVI, Bitmap, DICOM, GIF, TIFF, JPEG, MPEG, PNG, Windows Media, and storing the images in a storage medium including, but not limited to fixed disk drives, magnetic disks, optical disks, magneto-optical disks, random access memory, flash memory, or cache memory are also provided. Yet another embodiment is directed to methods of transferring images compressed in accordance with the invention by encoding the images in a transfer format, providing the images to an image source system, transferring the images from the image source system through an image transfer mechanism to an image receiving system. Transfer formats include, but are not limited to TCP/IP, IPX/SPX, NetBEUI, ATM, or 802.11. Transfer mechanisms include, but are not limited to, network, Internet, telephone line, satellite, wireless, microwave, or fibre.

### BRIEF DESCRIPTION OF THE DRAWINGS

FIG. 1 depicts a histogram of an exemplary subtracted image; and

FIG. 2 depicts a histogram of an exemplary thresholded, subtracted image.

### DETAILED DESCRIPTION OF THE INVENTION

Reference will now be made in detail to the presently preferred embodiments of the invention, which serve to explain the principles of the invention. It is to be understood that the application of the teachings of the present invention to a specific problem or environment will be within the capabilities of one having ordinary skill in the art in light of the teachings contained herein.

The present invention is directed to methods and systems for compressing a digital image series. These methods and systems achieve a substantial reduction of storage required for the image series, and increase the speed of transferring or transmitting the image series, or reduce the bandwidth required for transferring or transmitting the image series. The compression methods and systems of the invention exploit the information redundancy within a digital image series (e.g., a cross-sectional diagnostic image series) to deliver significantly higher compression ratios than existing lossless and near-lossless methods such as JPEG lossless, JPEG-LS, or JPEG2000 lossless. Preferred embodiments of the methods and systems of the invention also eliminate noise using an adaptive threshold to avoid removing significant information during compression (e.g., diagnostic information) unlike JPEG lossy, JPEG2000 lossy, and other common wavelet methods.

The methods and systems of the invention permit near-lossless and lossy compression of digital images to reduce the memory required to store digital image sets and the time or bandwidth required to transmit digital image sets. The compressed images can be decoded and uncompressed (“reconstructed”) at the receiving end of the transmission for display. The loss of significant information in reconstructed image sets is minimized using the methods and systems of the invention. The amount of additive noise and CPU time is minimized in accordance with preferred embodiments of the invention.

The term “digital image” refers to a series of pixels that represent an image and is capable of being stored in and retrieved from computer memory. The term “a series of digital images” refers to a set of images 1 to n where each image has an adjacent image (e.g., a preceding image or a subsequent image).

The term “subtracted image” refers to an image created by pixel-by-pixel subtraction of pixels from its adjacent image.

The term “random noise” refers to pixel values normally distributed around a mean value. Random noise has a mean value of zero in a subtracted image as long as the source of noise remains constant throughout the image series.

The term “thresholded image” refers to an image created by setting all pixel values whose absolute value is below a predetermined threshold number to zero.

The term “lossy compression” refers to an algorithm for which one or more reconstructed image pixels differ from its corresponding original image pixel. “Near lossless compression” refers to an algorithm for which each reconstructed image pixel differs from its corresponding original image pixel by not more than a pre-specified value. “Lossless compression” refers to an algorithm for which each reconstructed image pixel is identical to its corresponding original image pixel.

The term “entropy” refers to the amount of information in a signal. An image with many pixels with common pixel values is regarded as low entropy whereas an image with many pixels with varying pixel values is regarded as high entropy.

A preferred method of the invention is directed to a method of compressing a series of digital images by arranging the images in an ordered series from 1 to n wherein n is the last image in said series. The images may be arranged from first to last or last to first or in any other suitable logical sequence. The images can optionally be registered within a series to eliminate alignment errors due to patient movement. Image registration significantly reduces structural differences between images and thus reduces “structural noise” that may remain in a subtracted image by decreasing the number of non-zero pixel values. Image registration may include transformation, shearing, and other mathematical techniques to ensure that large structures that are present in adjacent images occupy the same relative position.

After the digital images are arranged in a series, each pixel of each of images 2 to n is subtracted from its corresponding pixel in its adjacent image 1 to (n−1). An “adjacent image” can be a previous adjacent image or a subsequent adjacent image. Pixels having an absolute value less than a “predetermined threshold value” are adjusted to zero. The methods and systems of the invention achieve significant additional compression ratios by this removal of “random noise” from subtracted images. Any “random noise” contained in the subtracted images should approximate a normal distribution with a mean pixel value of 0.

In one embodiment of the invention, the presence of “random noise” in each of the subtracted images is confirmed by applying a Normality Test to verify that suspected “random noise” generates a normal distribution. Suitable Normality Tests are well known in the art (e.g., NIST/SEMATECH e-Handbook of Statistical Methods, http://www.itl.nist.gov/div898/handbook/, 2003; Conover, W. J. 1980. Practical Nonparametric Statistics. 2nd ed. New York: John Wiley & Sons; D'Agostino, R. B. and Stephens, M. A., eds. 1986. Goodness-of-fit Techniques. New York: Dekker; Daniel, Wayne W. 1978. Applied Nonparametric Statistics. Boston: Houghton Mifflin hereby incorporated by reference in their entirety). A Normality Test verifies that pixel values are distributed within a preset tolerance of a normal distribution. Only the pixels that we are planning to set to zero by thresholding, excluding those pixels that already contain a value of zero, should be tested for normality. If suspected “random noise” is not within a normal distribution, it may contain non-random information. If a particular image fails a Normality Test, then a smaller threshold value must be selected or thresholding should not be performed because thresholding would have a high probability of removing significant information.

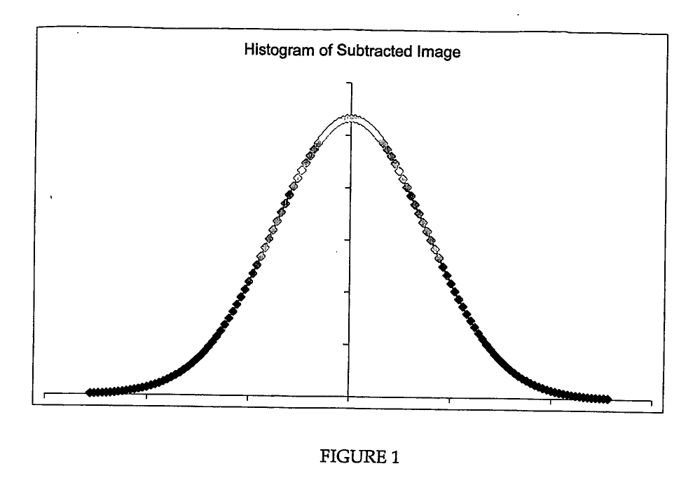

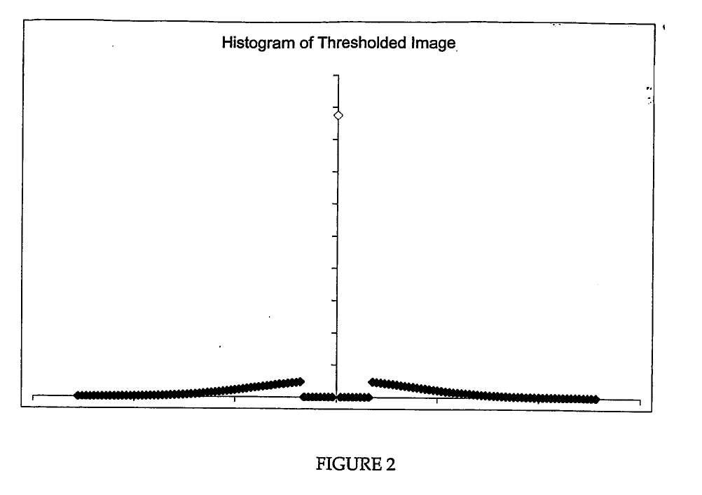

For example, if it is determined that 1.5 standard deviations of noise can be safely removed without loss of significant information, then the noise can be replaced with pixel values of zero. By removing the majority of noise in this subtracted image, the entropy contained within this subtracted image is reduced significantly as the image now contains many more zero valued pixels as depicted in FIG. 2 (Thresholded Histogram) when compared with FIG. 1 (Normal Histogram).

The following definitions are used in the examples that follow:
Iₙ(x,y)=Original pixels of image # n within the series
DIₙ(x,y)=Thresholded, subtracted image required to reconstruct image # n
σₙ=standard deviation of subtracted image # n
Iₙ′(x,y)=Reconstructed Image # n

An exemplary function (“Algorithm for Threshold (DIₙ)”) eliminates Gaussian noise from a subtracted image by modifying the input image to set pixels to 0 that are within a standard deviations of 0. For medical applications, α must be tuned to provide a diagnostically acceptable output.
If |DIₙ(x,y)|>α*σₙ then Output=DIₙ(x,y)
If |DIₙ|<=α*σₙ then Output=0

The resulting subtracted image is compressed using a suitable compression algorithm (e.g., JPEG lossy, JPEG lossless, JPEG 2000, JPEG-LS lossy, JPEG-LS near-lossless, Wavelet, RLE, Deflate, Lempel-Ziv) to form a compressed image. The size of an image can be reduced by at least about an additional 60% using the methods and systems of the invention.

Lossy compression can be achieved using the methods and systems of the invention according to the following exemplary algorithm:

Algorithm for Lossy Compression:
I₁′(x,y)=I₁(x,y)
DI₂(x,y)=Threshold(I₂(x,y)−I₁(x,y))
DIₙ(x,y)=Threshold(Iₙ(x,y)−Iₙ₋₁(x,y))
I₂′(x,y)=I₁(x,y)+DI₂(x,y)
Iₙ′(x,y)=Iₙ₋₁′(x,y)+DIₙ(x,y)

The compressed series consists of I₁ and DI₂ . . . DIₙ all of which are to be lossless or lossy compressed using JPEG, JPEG2000, or other standard methods.

Alternatively, embodiments of the invention provide near lossless compression. Near lossless compression requires that the maximum error in any pixel of the image is quantifiable. The objective is that the maximum error is to be within the magnitude of the “random noise.” This is achieved by using reconstructed images during the subtraction rather than original images. The reconstructed images contain the error introduced by thresholding. By accounting for that error during encoding, the decoder generates a more precise image with the only error introduced by a single thresholding step rather than an additive error propagating through each image. The following is an exemplary algorithm for near lossless compression:

Algorithm for Near-Lossless Compression:
I₁′(x,y)=I₁(x,y)
DI₂(x,y)=Threshold(I₂(x,y)−I₁(x,y))
I₂′(x,y)=I₁(x,y)+DI₂(x,y)
DIₙ(x,y)=Threshold(Iₙ(x,y)−Iₙ₋₁′(x,y))
Iₙ+(x,y)=Lₙ₋₁′(x,y)+DIₙ(x,y)

The compressed series consists of I₁ and DI₂ . .. DIₙ all of which are to be lossless compressed using JPEG, JPEG2000, or other standard methods.

The reconstructed images consist of I₁ and I₂′ . . . Iₙ′. The compressed series needs to be lossless decompressed using the associated method before addition.

Another embodiment of the invention is directed to decompressing an image or reconstructing the compressed images using an associated decompression algorithm to form thresholded images. Adding each of the pixels from each thresholded image with the pixels of its reconstructed previously adjacent image creates reconstructed images.

The Adaptive Slice Subtraction compression techniques have been designed to reintroduce “random noise” during the decoding process by preserving the noise in the first image. However, if desired, a noise reduction filter may be applied to the first image to reduce noise from the entire series. This results in a very fast filter to reduce noise. Decompression or decoding can be achieved, for example, as follows:

Input: A set of compressed files that were previously encoded using either of the above encoders.

Summary of Decoder:

1. Decompress the first image and the previously thresholded images using the associated decompression technique that reverses the compression technique used in the final step of the encoder. The first image has now been decoded.

2. Pixel-by-pixel addition of each of the previously thresholded images to the decoded adjacent image, starting with image #2.

Output: A set of reconstructed files comprised of images pertaining to a single series. These files should contain significant information that was present in the original data set. Any loss of pixel information is predominantly noise being discarded.

Preferred embodiments of the invention are directed to methods of storing the images compressed as described above. The compressed images are encoded in a storage format including, but not limited to AVI, Bitmap, DICOM, GIF, TIFF, JPEG, MPEG, PNG, or Windows Media, and stored in a storage medium including, but not limited to fixed disk drives, magnetic disks, optical disks, magneto-optical disks, random access memory, flash memory, or cache memory. The stored images can be retrieved from the storage medium and viewed, manipulated, or transmitted using a suitable computer system.

Another embodiment of the invention is directed to methods of transferring images compressed as described above. The images are encoded in a transfer format and provided to an image source system such as a computer system containing storage medium for the images. The images can then be transferred from the image source system through an image transfer mechanism (e.g., electronic mail) to an image receiving system such as a receiving computer system. Transfer formats include, but are not limited to TCP/IP, IPX/SPX, NetBEUI, ATM, or 802.11. Transfer mechanisms include, but are not limited to, network, Internet, telephone line, satellite, wireless, microwave, or fibre.

Preferred embodiments of the invention are also directed to computer systems for compressing a series of digital images comprising a computer processor; memory for storing a series of digital images; and logic embodied on a computer readable medium, including computer executable instructions for arranging said images in an ordered series from 1 to n wherein n is the last image in said series. The computer system subtracts each pixel of each of images 2 to n from its corresponding pixel in an adjacent image, creating a subtracted image. The pixel values are adjusted to zero for pixels having an absolute value less than a predetermined threshold value, creating a thresholded image. The thresholded images are compressed using a compression algorithm to form compressed images.

It is to be understood that the application of the teachings of the present invention to a specific problem or environment will be within the capabilities of one having ordinary skill in the art in light of the teachings contained herein. Preferred methods and systems of the invention appear in the following examples.

### EXAMPLE 1

Near-Lossless Example: Series of 3 images: 4 rows×4 columns×16 bits

Original pixels

| I₁ (16 bit image) | | | | I2 (16 bit image) | | | | I3 (16 bit image) | | | |
|---|---|---|---|---|---|---|---|---|---|---|---|
| 32 | 35 | 37 | 32 | 30 | 33 | 32 | 36 | 36 | 27 | 33 | 31 |
| 28 | 2050 | 2060 | 31 | 24 | 2140 | 1859 | 34 | 25 | 1987 | 2508 | 38 |
| 25 | 2040 | 2070 | 27 | 28 | 2039 | 1989 | 29 | 28 | 2839 | 2830 | 29 |
| 30 | 32 | 28 | 36 | 33 | 37 | 26 | 32 | 30 | 35 | 29 | 34 |

Subtracted pixels

| I₁ | | | | I₂ − I₁ | | | | O₃ − I₂′ | | | |
|---|---|---|---|---|---|---|---|---|---|---|---|
| 32 | 35 | 37 | 32 | −2 | −2 | −5 | +4 | +4 | −8 | −4 | −1 |
| 28 | 2050 | 2060 | 31 | −4 | +90 | −201 | +3 | −3 | −153 | +649 | +7 |
| 25 | 2040 | 2070 | 27 | +1 | −1 | −81 | +2 | +3 | +799 | +841 | +2 |
| 30 | 32 | 28 | 36 | +3 | +5 | −2 | −4 | 0 | +3 | +1 | −2 |

Threshold pixels

| I₁ | | | | DI₂ | | | | DI₃ | | | |
|---|---|---|---|---|---|---|---|---|---|---|---|
| 32 | 35 | 37 | 32 | 0 | 0 | 0 | 0 | 0 | 0 | 0 | 0 |
| 28 | 2050 | 2060 | 31 | 0 | +90 | −201 | 0 | 0 | −153 | +649 | 0 |
| 25 | 2040 | 2070 | 27 | 0 | 0 | −81 | 0 | 0 | +799 | +841 | 0 |
| 30 | 32 | 28 | 36 | 0 | 0 | 0 | 0 | 0 | 0 | 0 | 0 |

A lossless compression and associated decompression method can be applied at this point.

Reconstructed pixels

| I₁′ | | | | I₂′ | | | | I₃′ | | | |
|---|---|---|---|---|---|---|---|---|---|---|---|
| 32 | 35 | 37 | 32 | 32 | 35 | 37 | 32 | 32 | 35 | 37 | 32 |
| 28 | 2050 | 2060 | 31 | 28 | 2140 | 1859 | 31 | 28 | 1987 | 2508 | 31 |
| 25 | 2040 | 2070 | 27 | 25 | 2040 | 1989 | 27 | 25 | 2839 | 2830 | 27 |
| 30 | 32 | 28 | 36 | 30 | 32 | 28 | 36 | 30 | 32 | 28 | 36 |

Maximum Near-Lossless Compression Error:

The maximum error in any pixel of I₂ to Iₙ is the maximum of α* σₙ. By introducing an upper bound on α*σₙ, this method would qualify as near lossless compression. In the above example, it is evident that significant changes are preserved in the near lossless adaptive slice subtraction method. This would be the case if images within a series were poorly correlated.

### EXAMPLE 2

Lossy Example: Series of 3 images: 4 rows×4 columns×16 bits

Original pixels

| I₁ (16 bit image) | | | | I2 (16 bit image) | | | | I3 (16 bit image) | | | |
|---|---|---|---|---|---|---|---|---|---|---|---|
| 32 | 35 | 37 | 32 | 30 | 33 | 32 | 36 | 36 | 27 | 33 | 31 |
| 28 | 2050 | 2060 | 31 | 24 | 2140 | 1859 | 34 | 25 | 1987 | 2508 | 38 |
| 25 | 2040 | 2070 | 27 | 28 | 2039 | 1989 | 29 | 28 | 2839 | 2830 | 29 |
| 30 | 32 | 28 | 36 | 33 | 37 | 26 | 32 | 30 | 35 | 29 | 34 |

Subtracted pixels

| I₁ | | | | I₂ − I₁ | | | | O₃ − I₂′ | | | |
|---|---|---|---|---|---|---|---|---|---|---|---|
| 32 | 35 | 37 | 32 | −2 | −2 | −5 | +4 | +6 | −6 | +1 | −5 |
| 28 | 2050 | 2060 | 31 | −4 | +90 | −201 | +3 | −1 | −153 | +649 | +4 |
| 25 | 2040 | 2070 | 27 | +1 | −1 | −81 | +2 | 0 | +800 | +841 | 0 |
| 30 | 32 | 28 | 36 | +3 | +5 | −2 | −4 | −3 | −2 | +3 | +2 |

Threshold pixels

| I₁ | | | | DI₂ | | | | DI₃ | | | |
|---|---|---|---|---|---|---|---|---|---|---|---|
| 32 | 35 | 37 | 32 | 0 | 0 | 0 | 0 | 0 | 0 | 0 | 0 |
| 28 | 2050 | 2060 | 31 | 0 | +90 | −201 | 0 | 0 | −153 | +649 | 0 |
| 25 | 2040 | 2070 | 27 | 0 | 0 | −81 | 0 | 0 | +800 | +841 | 0 |
| 30 | 32 | 28 | 36 | 0 | 0 | 0 | 0 | 0 | 0 | 0 | 0 |

Any compression and associated decompression method can be applied at this point.

Reconstructed pixels

| I₁′ | | | | I₂′ | | | | I₃′ | | | |
|---|---|---|---|---|---|---|---|---|---|---|---|
| 32 | 35 | 37 | 32 | 32 | 35 | 37 | 32 | 32 | 35 | 37 | 32 |
| 28 | 2050 | 2060 | 31 | 28 | 2140 | 1859 | 31 | 28 | 1987 | 2508 | 31 |
| 25 | 2040 | 2070 | 27 | 25 | 2040 | 1989 | 27 | 25 | 2840 | 2830 | 27 |
| 30 | 32 | 28 | 36 | 30 | 32 | 28 | 36 | 30 | 32 | 28 | 36 |

Maximum Lossy Compression Error:

The maximum error in any pixel of I₂ to Iₙ is now αⁿ(Σ σᵢ). In practice, the actual error should be very small so long as the thresholding function is not removing clinically relevant data and only removing noise. Random noise is distributed uniformly around 0 and should not accumulate to create a significant problem in this regard. In the above example, it is clear that there is just a small difference in the output of the lossy version of adaptive slice subtraction when compared with the near lossless version. Nonetheless, this technique would not qualify as near lossless even if lossless compression techniques were employed in conjunction with the lossy slice subtraction method.

This software will be used by PACS and teleradiology software companies to significantly reduce the storage requirements for diagnostic images. The length of time necessary to transmit a study or the transmission bandwidth required will also be reduced significantly. The users will require a software toolkit in the form of an Application Programming Interface (API). This API will contain a function to compress a DICOM study and a second function to decompress the DICOM study. This software can be integrated into existing systems with minimal integration work required.

### EXAMPLE 3

CT Study

Initial tests were performed using a 4 detector CT exam at 512×512×16 bits with average image sizes, uncompressed, at 512 KB, and JPEG lossless compression at 200 KB.

Near lossless slice subtraction where α=1.5 was conducted in accordance with preferred methods of the invention followed by JPEG lossless compression at 80 KB. Lossy slice subtraction where α=1.5 followed by JPEG lossless compression at 50 KB resulted in a visually comparable reconstructed image when compared side by side with the original image.

Decreasing α did not significantly improve the visual appearance of the reconstructed images, but increased file sizes significantly.

Increasing α began to degrade the visual appearance of the reconstructed images, but decreased file sizes significantly.

Preferably, the appropriate setting of α is determined as this constant universally influences the size of the threshold range. Preferably, the largest possible value that does not visually degrade the reconstructed images is also chosen. At the same time, it is preferable to choose a small enough value such that the vast majority of our subtracted images satisfy the Normality Test.

The above description is only illustrative of preferred embodiments which achieve the objects, features, and advantages of the present invention, and it is not intended that the present invention be limited thereto. Any modifications of the present invention which come within the spirit and scope of the following claims are considered part of the present invention.

What is claimed as new and desired to be protected by Letters Patent of the United States is:

1. A method of compressing a series of digital images comprising:
arranging said images in an ordered series from 1 to n wherein n is the last image in said series;
subtracting the value of each pixel of each of images 2 to n from its corresponding pixel in an adjacent image to form subtracted images 2 to n;
adjusting the pixel value to zero for pixels of each of subtracted images 2 to n having absolute values of less than a predetermined threshold value; and
compressing said images of said series 1 to n using a compression algorithm to form compressed images.

2. A method of decompressing the compressed images of claim 1, comprising:
reconstructing the compressed images of claim 1 using an associated decompression algorithm to form thresholded images; and
adding each pixel from each of the thresholded images 2 to n with the corresponding pixel in its adjacent reconstructed or original image 1 to (n−1).

3. The method of claim 1 wherein said adjacent image is a reconstructed image.

4. The method of claim 1 wherein said threshold value is adjusted such that said threshold value is less than a noise tolerance threshold for said pixels of each subtracted image.

5. The method of claim 4 wherein said threshold value is adjusted to the maximum possible value that satisfies a normal distribution test for said pixels of each subtracted image.

6. The method of claim 1 wherein said digital images are aligned with respect to each other.

7. The method of claim 1 further comprising applying a noise reduction filter to one or more images.

8. A method of storing images compressed in accordance with claim 1, comprising encoding said images in a storage format and storing said images in a storage medium.

9. The method of claim 8, wherein said storage format is selected from the group consisting of AVI, Bitmap, DICOM, GIF, TIFF, JPEG, MPEG, or PNG, or Windows Media.

10. The method of claim 8, wherein said storage medium is selected from the group consisting of fixed disk drives, magnetic disks, optical disks, magneto-optical disks, random access memory, flash memory, or cache memory.

11. A method of transferring images compressed in accordance with the method of claim 1, comprising encoding said images in a transfer format, providing said images to an image source system, transferring the images from the image source system through an image transfer mechanism to an image receiving system.

12. The method of claim 11, wherein said transfer format is selected from the group consisting of TCP/IP, IPX/SPX, NetBEUI, ATM, or 802.11.

13. The method of claim 11, wherein said transfer mechanism is selected from the group consisting of network, Internet, telephone line, satellite, wireless, mnicrowave, or fibre.

14. A computer system for compressing a series of digital images, the computer system comprising:
a computer processor;
memory for storing a series of digital images; and
logic embodied on a computer readable medium, including computer executable instructions for arranging said images in an ordered series from 1 to n wherein n is the last image in said series; subtracting value of each pixel of each of images 2 to n from its corresponding pixel in an adjacent image to form subtracted images 2 to n; adjusting the pixel value to zero for pixels of each of subtracted images 2 to n having absolute values less than a predetermined threshold value to create thresholded images; and compressing said image 1 and the said thresholded images 2 to n using a compression algorithm to form compressed images.

15. A computer system for decompressing a series of digital images, the computer system comprising:
a computer processor;
memory for storing a series of digital images; and
logic embodied on a computer readable medium, including computer executable instructions for reconstructing the compressed images of claim 1 using an associated decompression algorithm to form thresholded images; adding each pixel from each of thresholded images 2 to n with the corresponding pixel in its adjacent reconstructed or original image 1 to (n−1).
